(19) United States
(12) Patent Application Publication
(10) Pub. No.: US 2007/0013154 A1
(43) Pub. Date: Jan. 18, 2007

(54) Adjustable creeper apparatus

(75) Inventor: Michael R. Staples, Mauldin, SC (US)

Correspondence Address: DORITY & MANNING, P.A., POST OFFICE BOX 1449, GREENVILLE, SC, 29602-1449, US

(73) Assignee: International Specialty Services, Inc.

(21) Appl. No.: 11/182,518

(22) Filed: Jul. 15, 2005

(51) Int. Cl. B25H 5/00

(52) U.S. Cl. 280/32.6

(57) ABSTRACT

A creeper that has a body portion with a longitudinal axis and a transverse axis perpendicular to the longitudinal axis is provided. The creeper also includes an end portion that is adjustable with respect to the body portion. A locking mechanism is present that engages both the body portion and the end portion. The locking mechanism is configured for limiting adjustability between the body portion and the end portion. An actuator is present and is configured to allow manual operation of the locking mechanism. The actuator has a first end connected to the locking mechanism and a handle disposed opposite from the first end and longitudinally disposed from the end portion.

### CROSS-REFERENCE TO RELATED APPLICATIONS

N/A

### FEDERALLY SPONSORED RESEARCH OR DEVELOPMENT

N/A

### BACKGROUND

Creepers are used by mechanics in order to assist in providing access to the undercarriage of an automobile or other mechanism for purposes of repair or maintenance. Creepers usually include a body portion onto which a mechanic will lay. A headrest for the head of a mechanic is often provided as well. The mechanic typically lies on his or her back on a body portion of the creeper and positions the creeper to a desired location under the automobile or mechanism. Casters are attached to the body portion in order to allow the creeper to be easily moved in various directions by the mechanic.

The body portion is generally rectangular shaped and may be made, for instance, out of plywood or may be a structure that includes a metal frame that supports a padded body-supporting member onto which the mechanic lies. A rectangular shaped body portion is generally desirable because this shape accommodates the body of the mechanic and provides an advantageous wheelbase for the casters. The upper surface of the body portion is typically flat. The body portion could also be a molded member so as to be shaped in order to receive the torso, legs and/or head of the mechanic.

Creepers have been designed so that the headrest portion may be adjusted with respect to the body portion. In this manner, the upper surface of the headrest portion may be angularly adjusted with respect to the upper surface of the body portion and subsequently locked into a desired angular position through the use of a locking mechanism. Angular adjustment of the headrest allows for a great degree of mechanic comfort when using the creeper. This type of adjustment may be desirable in that the mechanic may spend extended amounts of time using the creeper while fixing a problem with an automobile or other mechanism.

Unfortunately, it is sometimes the case that portions of the locking mechanism, such as a handle, interfere with the mechanic as they are located next to the headrest and consequently the head and shoulders of the mechanic. These portions of the locking mechanism may prevent the mechanic from accessing certain areas during use of the creeper and may impair his or her view. Additionally, these portions of the locking mechanism may actually pinch or otherwise undesirably contact the mechanic during use.

### SUMMARY

The present invention provides for an improved creeper that incorporates a locking mechanism to limit the adjustability between an end portion of the creeper and a body portion of the creeper. A handle of the locking mechanism is located away from the end portion of the creeper to prevent or minimize interference with the user of the creeper.

Various features and advantages of the invention will be set forth in part in the following description, or may be obvious from the description, or may be learned from practice of the invention.

A creeper is provided that has a body portion with a longitudinal axis and a transverse axis that is perpendicular to the longitudinal axis. An end portion is also included and is adjustable with respect to the body portion. The creeper has a locking mechanism that engages both the body and the end portions. The locking mechanism is configured for limiting the adjustability between the body portion and the end portion. An actuator is present and is configured to allow manual operation of the locking mechanism. The actuator has a first end connected to the locking mechanism and a handle that is disposed opposite from the first end and longitudinally from the end portion.

Also provided is a creeper as discussed above that further includes a plurality of casters that are attached to the body portion. At least two of the casters may be located longitudinally between the end portion and the handle.

A further exemplary embodiment exists in a creeper as previously discussed in which the handle is located away from a side of the body portion in the transverse direction.

An additional embodiment of the creeper exists as previously discussed in which the locking mechanism is configured for locking the position of the end portion with respect to the body portion.

Also provided is a creeper as discussed above in which the heart of a user is located between the handle and the end portion in the longitudinal direction when the user lays on the body portion and rests his or her head on the end portion.

The present invention also provides for a creeper as previously discussed where the end portion is adjustable so that an upper surface of the end portion is in substantially the same plane as an upper surface of the body portion. The handle may be longitudinally disposed from the end portion a length that is as least as great or greater than the longitudinal length of the upper surface of the end portion when in substantially the same plane as the upper surface of the body portion.

The present invention also provides for a creeper that has a body portion with a longitudinal axis and a transverse axis that is perpendicular to the longitudinal axis. The body portion has an upper surface. A plurality of casters and a hinge are attached to the body portion. An end portion with an upper surface is attached to the hinge and is adjustable with respect to the body portion. Adjustment of the end portion includes changing the angular orientation of the upper surface of the end portion with respect to the upper surface of the body portion. A locking mechanism is provided and engages both the body portion and the end portion. The locking mechanism is configured for limiting the angular orientation of the upper surface of the end portion with respect to the upper surface of the body portion in at least one direction. An actuator is also provided and is configured to allow manual operation of the locking mechanism. The actuator has a first end connected to the locking mechanism and a handle disposed opposite from the first end.

The present invention also provides for a creeper as previously discussed in which the locking mechanism is configured for locking the angular orientation of the upper surface of the end portion with respect to the upper surface of the body portion.

The present invention also provides for creeper as previously discussed in which at least two of the casters are located longitudinally between the end portion and the handle.

Also provided for is a creeper as previously discussed in which the handle is longitudinally disposed from the hinge a length that is at least as great or greater than the longitudinal length of the end portion.

Also provided for in accordance with one exemplary embodiment is a creeper as previously discussed in which the heart of a user is located between the handle and the end portion in the longitudinal direction when a user lays on the upper surface of the body portion and rests his or her head on the upper surface of the end portion.

Also provided for in accordance with one exemplary embodiment is a creeper that includes a body portion with a longitudinal axis and a transverse axis that is perpendicular to the longitudinal axis. The body portion has an upper surface. A plurality of casters and a hinge are attached to the body portion. An end portion is provided and is attached to the hinge and is adjustable with respect to the body portion. The end portion has an upper surface and adjustment of the end portion includes changing the angular orientation of the upper surface of the end portion with respect to the upper surface of the body portion. A locking mechanism is included that engages both the body portion and the end portion. The locking mechanism is configured for locking the angular orientation of the upper surface of the end portion with respect to the upper surface of the body portion. An actuator is present and allows for manual operation of the locking mechanism. The actuator has a first end connected to the locking mechanism and a handle that is longitudinally disposed away from the end portion and transversely disposed from the upper surface of the body portion. At least two casters are locaters longitudinally between the end portion and the handle.

These and other features, aspects and advantages of the present invention will become better understood with reference to the following description and appended claims. The accompanying drawings, which are incorporated in and constitute part of the specification, illustrate embodiments of the invention, and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is a top view of a creeper in accordance with one exemplary embodiment.

FIG. 2 is a side view of the creeper of FIG. 1.

FIG. 3 is a bottom view of the creeper of FIG. 1.

FIG. 4 is a perspective view of the creeper of FIG. 1 that shows a user laying on the creeper so that the back of the user is on an upper surface of the body portion of the creeper and the head of the user is on an upper surface of an end portion of the creeper.

FIG. 5 is a bottom view of a creeper in accordance with an alternative exemplary embodiment.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to about 7 also includes a limit of to about 5, up to about 3, and up to about 4.5.

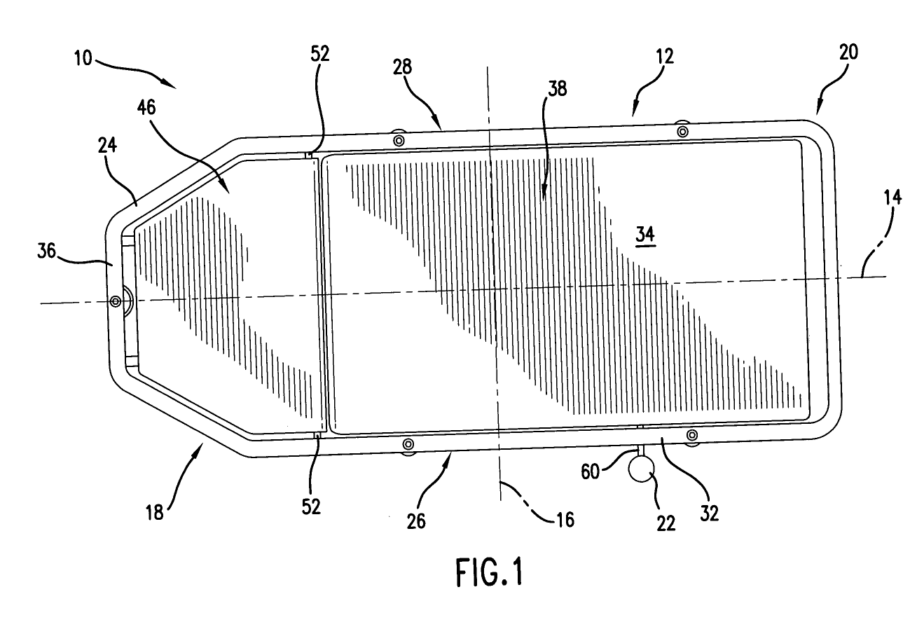

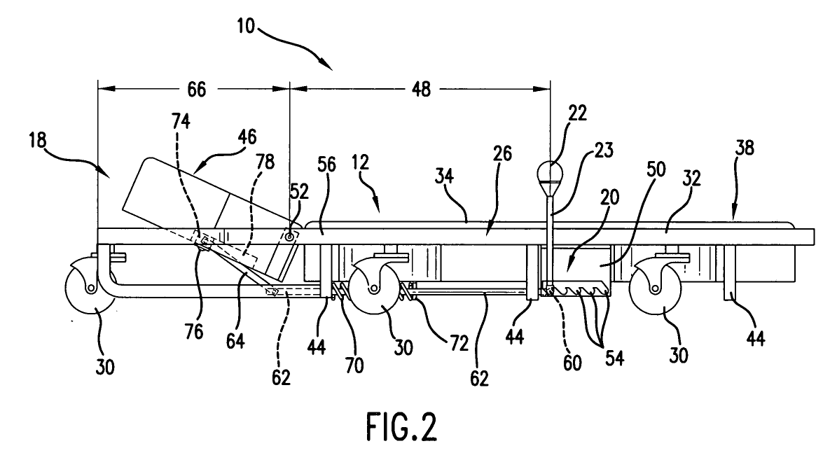

Referring to FIGS. 1 and 2 for example, the present invention provides for a creeper 10 that has an end portion 18 capable of being adjusted with respect to a body portion 12. A locking mechanism 20 is employed in order to help adjust an/or fix the orientation of the end portion 18 with respect to the body portion 12. Adjustment of the end portion 18 may allow for improved comfort during use of the creeper 10 as a user's 36 head, neck and/or shoulders may be better supported during use. An actuator 23 is provided and has a handle 22 that may be employed during adjustment, locking, or unlocking of the locking mechanism 20. The handle 22 is oriented on the creeper 10 so as to be distanced in the longitudinal direction from the end portion 18. This arrangement prevents interference of the handle 22 with the user 36 of the creeper 10 as the handle 22 is positioned away from the head of the user 36. The user 36 is more easily able to view the automobile or mechanism that is being worked upon as the handle 22 is positioned away from the face of the user 36. Additionally or alternatively, placement of the handle 22 away from the end portion 18 helps prevent pinching or other undesirable contact between the head and/or the shoulders of the user 36 and the handle 22.

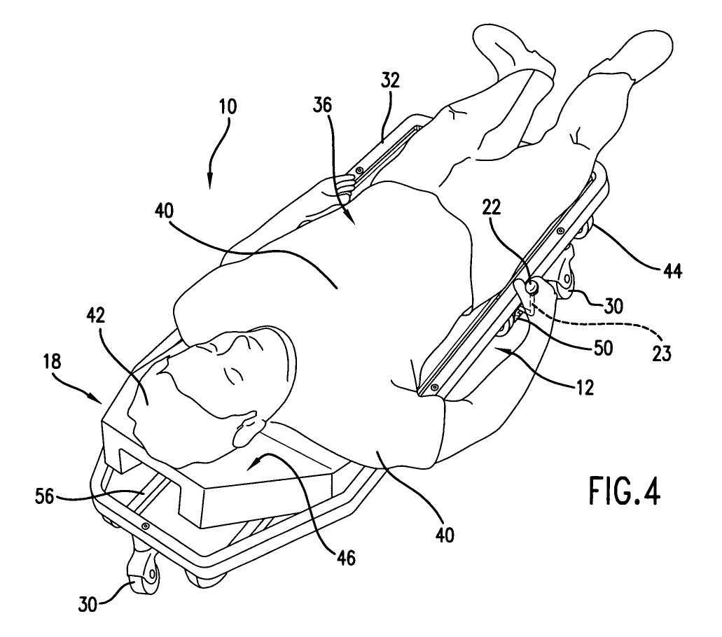

The body portion 12 includes an upper surface 38. Likewise, the end portion 18 includes an upper surface 46. As shown in FIG. 4, the user 36 may lie on the upper surface 38 of the body portion 12 so that his or her shoulders are located on an end of the upper surface 38 while his or her head 42 is located on the upper surface 46 of the end portion 18. In this manner, the user 36 may lay on the creeper 10 to access the underside of an automobile or other mechanism. However, it is to be understood that in accordance with other exemplary embodiments that the user 36 may lay in a completely opposite direction on the creeper 10 or may have various portions of his or her body supported by the creeper 10.

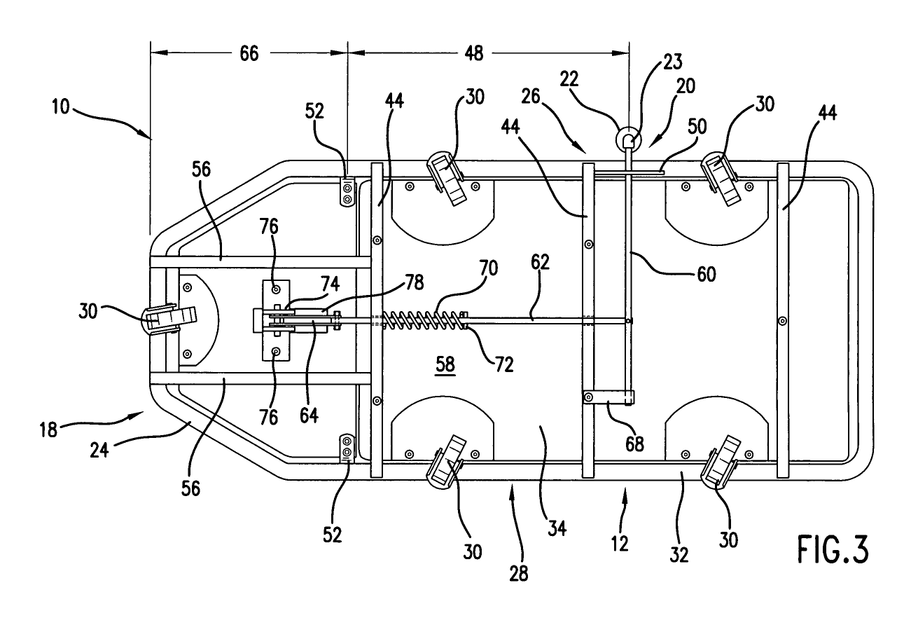

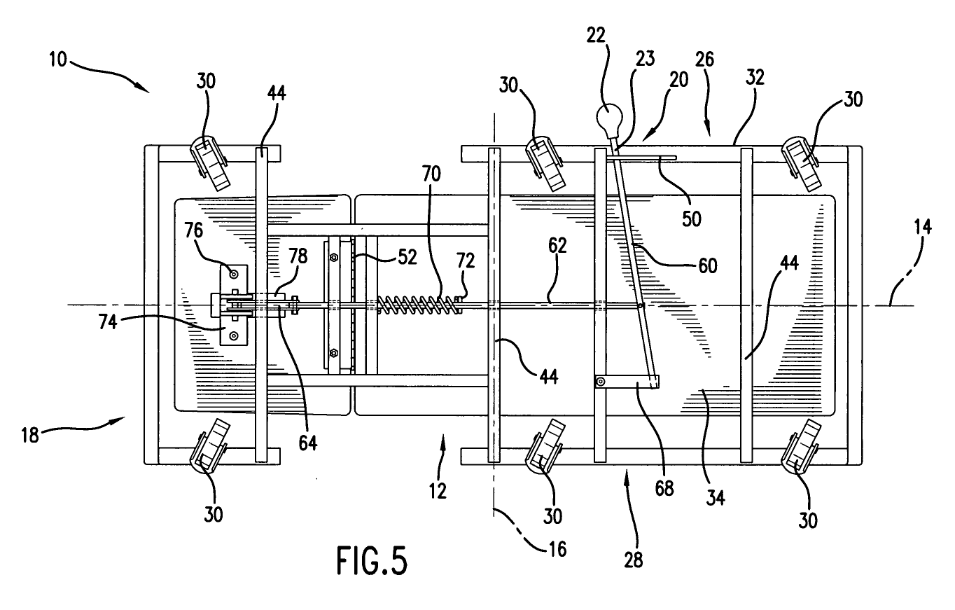

FIG. 3 shows the locking mechanism 20 of the creeper 10 in greater detail. It is to be understood that the locking mechanism 20 may be variously constructed in accordance with different exemplary embodiments. The locking mechanism 20 shown and described is but one exemplary embodiment and it to be understood that other configurations are possible. As shown in FIG. 3, the actuator 23 includes a handle 22 that may be grasped and manipulated by the user 36. A first rod 60 extends from the actuator 23 generally in the transverse direction of the creeper 10. The first rod 60 may be rigidly attached to the actuator 23 through welding, bolts, or any other suitable attachment. Alternatively, the actuator 23 and first rod 60 may be integrally formed with one another so as to be as single piece as shown, for example, in FIG. 5.

The rod 60 is provided with a pivot point on an end opposite from the actuator 23. In this regard, a pivot member 68 may extend from one of the cross bars 44 of the frame 32 in the body portion 12. The pivot member 68 is shown as being a U-shaped member that is attached to both the upper and lower portions of the cross bar 44. The end of the first rod 60 lies against and is urged against the inside of the pivot member 68. When the user 36 manipulates the handle 22 the first rod 60 pivots on the pivot member 68. As such, the pivot member 68 provides for stability in the locking mechanism 20 during adjustment with the handle 22. The pivot member 68 may be made of any suitable material. For example, the pivot member 68 may be made of steel in accordance with one exemplary embodiment. Although shown as a U-shaped member, the pivot member 68 may be variously configured in accordance with other exemplary embodiments. For example, the pivot member 68 may be configured as a ball and socket type joint. In this manner, the end of the first rod 60 may be dome shaped and may be received within a cup that extends from either the cross bar 44 or bottom of the body supporting member 34. It is to be understood that the pivot member 68 shown and described is but one exemplary embodiment that may be employed in the present invention and that others are possible.

An end of a second rod 62 is pivotably attached to the first rod 60 at a location along the length of the first rod 60. The pivotable attachment between the first rod 60 and the second rod 62 may be effected through a pin that is inserted through the first rod 60 and is received in a hole at the end of the second rod 62. A bushing may be employed in the connection in order to provide for a desired degree of pivotability between these two members. It is to be understood, however, that other pivoting arrangements between the first and second rods 60 and 62 may be used.

The second rod 62 extends generally in the longitudinal direction of the creeper 10. Holes may be drilled through the cross bars 44, if necessary, in order to accommodate passage of the second rod 62 therethrough. The second rod 62 extends from the first rod 60 and is positioned across body portion 12 and ends at the end portion 18 some distance past the hinge 52. A coil spring 70 is provided and has one end that engages the cross bar 44 that is proximate to the end portion 18 and has an opposite end that engages a pin 72 that is disposed through the second rod 62. The coil spring 70 provides a force to the second rod 62 that urges the second rod 62 in the longitudinal direction of the creeper 10 away from the end portion 18. The force provided by the coil spring 70 is transferred through the second rod 62 and into the first rod 60 to urge the first rod 60 to pivot about the pivot member 68. As such, if the handle 22 of the locking mechanism 20 was not engaged the force of the coil spring 70 would act to pivot the first rod 60 so that the handle 22 was moved generally in the longitudinal direction of the creeper 10 away from the end portion 18. The coil spring 70 acts to provide a desired stabilizing force in the locking mechanism 20. The coil spring 70 may be selected to have any desired spring tension so that any desired force is provided.

The locking mechanism 20 also includes a third rod 64 that is pivotably attached to an end of the second rod 62. The pivotable attachment between the second and third rods 62 and 64 may be accomplished by any mechanism. For example, a pin may be disposed through both the second and third rods 62 and 64 in order to provide for the desired pivoting. Additionally, the pivotable connection between the second and third rods 62 and 64 may be made to have any desired degree of tightness. An end of the third rod 64 may have a clevis that receives an end of the second rod 62 and also the pin or bolt that is used to attach these two components and provide the desired pivoting.

The first and second rods 60 and 62 may be variously configured in accordance with other exemplary embodiments. For instance, the rods 60 and 62 may be solid elongated objects that have a circular cross-section. Alternatively, the rods 60 and 62 may be hollow members or may have U-shaped or square cross-sections in accordance with other exemplary embodiments.

The third rod 64 may be configured as a hollow U-shaped member in accordance with one exemplary embodiment. On an end opposite the second rod 62, the third rod 64 may be pivotably mounted to a mounting member 74. In this regard, the third rod 64 may have a clevis on one end that receives a pin that is attached to the mounting member 74. Although shown as being capable of pivoting with respect to the mounting member 74, it is to be understood that the third rod 64 may be rigidly attached to the mounting member 74 in accordance with other exemplary embodiments. The mounting member 74 is rigidly attached to the bottom of the end portion 18 by a pair of bolts 76. The bottom of the end portion 18 defines a recess 78 that receives a portion of the mounting member 74 and also accommodates pivoting of the third rod 64 with respect to the mounting member 74. As the end portion 18 pivots with respect to the body portion 12, the third rod 64 will likewise pivot about the mounting member 74. As such, the recess 78 is sized to accommodate any possible degree of movement of the third rod 64.

During use, a user 36 may grasp the handle 22 and move the handle 22 in a longitudinal direction of the creeper 10 towards the end portion 18. Doing so will cause the actuator 23 and first rod 60 to pivot about the pivot member 68 and move generally in the longitudinal direction of the creeper 10 towards the end portion 18. The second rod 62 will likewise be forced towards the end portion 18 in the longitudinal direction of the creeper 10 thus compressing the coil spring 70. Resistive force by the coil spring 70 to compression will provide a controlled adjustment of the locking mechanism 20. Movement of the second rod 62 in the longitudinal direction of the creeper 10 towards the end portion 18 will likewise cause the third rod 64 to be moved in a similar direction. Force transmitted through the third rod 64 will be imparted into the end portion 18 through the mounting members 74 thus causing the end portion 18 to pivot about the hinge 52 in an upward direction.

The locking mechanism 20 may be locked at a desired position as will be momentarily discussed so as to cause the end portion 18 to be positioned at a desired angular orientation with respect to the body portion 12. Although described as completely locking the angular orientation of the end portion 18 with respect to the body portion 12, it is to be understood that in accordance with other exemplary embodiments that the locking mechanism 20 may be configured so as to only limit angular orientation of the end portion 18 in a particular direction. For instance, the locking mechanism 20 may be constructed so as to prevent the end portion 18 from pivoting about the hinge 52 in one direction but not the other.

In order to orient the end portion 18 in an opposite direction, the handle 22 may be released or may be moved in a longitudinal direction of the creeper 10 away from the end portion 18. Doing so will essentially reverse all of the previously described movements of the locking mechanism 20. In this regard, potential energy built up in the coil spring 70 may be released so as to “push” the locking mechanism 20 so that the end portion 18 will be angled downwards with respect to the body portion 12.

Referring now to FIG. 2, an adjustment rack 50 is shown attached to the body portion 12. The adjustment rack 50 defines a plurality of adjustment locations 54. The adjustment locations 54 correspond to different angular positions of the end portion 18 with respect to the body portion 12. The user 36 may grasp the handle 22 and move the handle 22 in the longitudinal direction of the creeper 10 to various locations in the adjustment rack 50. The user 36 may then position the handle 22 so that the first rod 60 is received within a desired adjustment location 54 in order to position the end portion 18 at a desired angular orientation. The first rod 60 is urged against the particular adjustment location 54 by the force of the coil spring 70 as previously described. The user 36 may then grasp the handle 22 to remove the first rod 60 from the adjustment location 54 once a different angular orientation of the end portion 18 is desired.

It is to be understood that the locking mechanism 20 may be variously configured in accordance with other exemplary embodiments. For example, the locking mechanism 20 need not include the first rod 60, second rod 62, third rod 64, coil spring 70 and/or mounting member 74 along with other associated components in accordance with various exemplary embodiments. It is to be understood that the particular configurations of the locking mechanism 20, that are shown as incorporating a linkage, are provided only by way of example and that other configurations are possible in accordance with other exemplary embodiments. For example, the locking mechanism 20 may simply be a pin with a handle 22 that engages a slot so as to limit the position of the end portion 18 with respect to the body portion 12. As such, it should be understood that the locking mechanism 20 may be variously configured in accordance with other exemplary embodiments and that the configuration shown and described are only examples.

As shown in FIG. 4, the user 36 may lay on the upper surface 38 of the body portion 12 so that his or her head is positioned on to the upper surface 46 of the end portion 18. The upper surface 38 may support the user's 36 latissimus dorsi muscles and kidneys. When laying on the creeper 10, the handle 22 may be positioned roughly at the side of the user 36 such that the heart 40 of the user 36 is located in the longitudinal direction of the creeper 10 between the handle 22 and the end portion 18. Positioning of the handle 22 away from the end portion 18 prevents interference with the user 36 in that the handle 22 will not obstruct the view of the user 36 during use of the creeper 10 and may prevent unwanted contact with the head, arms, hands, or tools that may be employed by the user 36. As such, the handle 22 may be positioned out of the way of the face and arms of the user 36 so that interference during use of the creeper 10 is avoided.

The handle 22 may be located in the longitudinal direction so that a pair of casters 30 are located between the handle 22 and the end portion 18 in the longitudinal direction. Additionally or alternatively, the handle 22 may be positioned a longitudinal distance 48 from the end portion 18. In accordance with certain exemplary embodiments, the longitudinal distance 48 may be up to 6 inches, up to 12 inches, up to 18 inches, up to 24 inches, or up to 30 inches in accordance with various exemplary embodiments. As shown in FIG. 3, the end portion 18 may have a longitudinal length 66. In accordance with certain exemplary embodiments; the longitudinal distance 48 may be at least as great or greater than the longitudinal length 66. However, it is to be understood that in accordance with other exemplary embodiments that the longitudinal distance 48 may be less than the longitudinal length 66. The handle 22 may be located in the transverse direction of the creeper 10 so as to be outboard from the side portion 26 of the body portion 12.

FIG. 5 shows another exemplary embodiment of the creeper 10 that includes a body portion 12 and an end portion 18 that are configured differently than those shown in the exemplary embodiment of FIGS. 1-4. It is to be understood that the locking mechanism 20 may be employed with creepers 10 that are variously configured in accordance with different exemplary embodiments. As shown in FIG. 5, the locking mechanism 20 is substantially the same as that as previously described in FIGS. 1-4. However, the handle 22 and actuator 23 in the exemplary embodiment of FIG. 5 extends generally only in the transverse direction of the creeper 10 and not in a vertical direction towards or above the upper surface 38 of the body portion 12 as does the handle 22 and actuator 23 in the previously described embodiments. As such, the handle 22 and actuator 23 as shown in FIG. 5 extends generally only in the transverse direction. Also, the handle 22 is located at least partially under a portion of the frame 32 in the body portion 12. As such, the handle 22 does not have to be the outward most projecting part of the creeper 10 in accordance with other exemplary embodiments. As shown in FIG. 5, the handle 22 may be located under a portion of the frame 32 so as to further isolate the handle 22 from the user 36 during use of the creeper 10. The actuator 23 may be an end of the first rod 60 so that these two components are essentially a single piece. The creeper 10 may be configured as that shown in U.S. patent application Ser. No. 11/068,558 entitled “Creeper Apparatus” filed Feb. 28, 2005, the entire contents of which are incorporated by reference herein in their entirety for all purposes.

Other features of the creeper 10 will now be described in greater detail. FIGS. 1-4 show a creeper 10 that includes a body portion 12 and end portion 18 with a frame 32 and a body-supporting member 34. The frame 32 is used in order to support the body-supporting member 34, and the body-supporting member 34 provides an area onto which the user 36 will lie. The body-supporting member 34 may be padded so as to increase the comfort of the user 36 during use. Alternatively, the body-supporting member 34 need not be padded in other exemplary embodiments. For example, the body-supporting member 34 may be a sheet of metal or a surface made from plywood in accordance with other exemplary embodiments.

As shown in FIG. 1, the body portion 12 includes a longitudinal axis 14 and a transverse axis 16 that is perpendicular to the longitudinal axis 14. The body portion 12 may be elongated in the longitudinal direction. The body portion 12 also includes first and second side portions 26 and 28 that extend in the longitudinal direction. The first and second side portions 26 and 28 may be substantially parallel to one another such that they are substantially parallel to the longitudinal axis 14 in accordance with certain exemplary embodiments. Alternatively, the side portions 26 and 28 may be angled to one another in other exemplary embodiments.

The underside of the creeper 10 is shown in FIG. 3 that notes the positioning of the casters 30. The casters 30 are stem-type casters mounted onto the frame 32. Five casters 30 are employed and are capable of rotating 360° so as to enable the creeper 10 to be moved in any direction on the surface onto which the creeper 10 rests. Although shown as employing five casters 30, it is to be understood that any suitable number of casters 30 may be used in accordance with various exemplary embodiments and that the casters 30 may be located at different locations on the body portion 12. For instance, the casters 30 may be mounted onto the body-supporting member 34 instead of or in addition to the frame 32. Any suitable caster 30 may be employed in the creeper 10. For instance, a 30 series caster having a wheel diameter of 3 inches and a pound capacity of 350 pounds with a wheel made of cast iron distributed by RWM Casters of 1225 Isley Road, Gastonia, N.C. 28053 may be employed. Although shown as employing a stem-type mounting, the casters 30 may have a rectangular mounting so as to be bolted, welded, or otherwise attached to the frame 32 in accordance with other exemplary embodiments. Further, although described as being capable of rotating 360° it is to be understood that the casters 30 may be selected so that they are only capable of rotating less than 360°. Further, the casters 30 may be selected so that they are not rotatable in accordance with various exemplary embodiments. In this case, the casters 30 are fixed so as to only allow the creeper 10 to move in a linear direction.

The body-supporting member 34 is a padded component to provide both support and comfort to the user 36. The body-supporting member 34 may be made from several different layers of different material. For instance, the outer layer of the body-supporting member 34 that forms the surfaces 38 and 46 may be made from any suitable type of material such as vinyl or cloth. Next, a foam material may be provided so as to provide for padding properties of the body-supporting member 34. Any suitable type of foam may be used. For example, the foam may be a neoprene, polyethylene, or EVA foam manufactured by Reed Rubber and Foam Products, 1615 North 25^{th} Street, Saint Louis, Mo. 63106. Beneath the foam, the body-supporting member 34 may include a piece of wood, such as plywood, so as to provide for structural support of the foam. Instead of wood, a flat piece of metal such as steel or aluminum may be used. The vinyl material or cloth material making up the surfaces 38 and 46 may be wrapped around the wood layer and attached thereon. FIG. 3 shows a skirt 58, that may be made from a felt material, attached to the wood layer of the body-supporting member 34 for aesthetic purposes so that a user of the creeper 10 will not see the wood layer. The skirt 58 is shown stapled onto the wood layer of the body-supporting member 34, although various ways of attaching the skirt 58 may be employed. The skirt 58 and/or layers of the body-supporting member 34 may be attached to one another through bolts or other attachments commonly known to one having ordinary skill in the art. Although described as being multiple layers, it is to be understood that the body-supporting member 34 may be made of only a single layer in accordance with other exemplary embodiments. For instance, the body-supporting member 34 may be made from a single piece of plastic, aluminum, steel or wood in accordance with various exemplary embodiments.

A series of crossbars 44 are included in the frame 32 so as to help support the body-supporting member 34. The crossbars 44 can be bolted onto the body-supporting member 34 through the skirt 58. Although shown as employing three crossbars 44, it is to be understood that any number of, or zero, crossbars 44 may be used in accordance with other exemplary embodiments. Additionally, although shown as being substantially parallel to the transverse direction, the crossbars 44 may be angled in other exemplary embodiments so as to extend in both the longitudinal and transverse directions.

A pair of longitudinally extending bars 56 are also included and are attached to the frame 32 in the end portion 18. The body-supporting member 34 in the end portion 18 rests and is supported upon the longitudinally extending bars 56. The longitudinally extending bars 56 can be connected to one end of the crossbars 44 and the other ends of the bars 56 can be connected a tip portion 24 of the end portion 18. The longitudinally extending bars 56 aid in supporting the body-supporting member 34 in the end portion 18 due to the fact the body-supporting member 34 in the end portion 18 is hingedly attached to the body-supporting member 34 in the body portion 12.

Referring to FIG. 1, a hinge 52 may be employed so as to allow the body-supporting member 34 to pivot between the end portion 18 and the body portion 12. Hinge 52 is shown as a pin that extends through the body-supporting member 34 in the end portion 18 and is retained on either end by the frame 32. The hinge 52 may be rotatably engaged or non-rotatably engaged with the frame 32. Additionally, the hinge 52 may be in engagement with wood or foam in the body-supporting member 34. The hinge 52 employed may be of any type commonly known to one having ordinary skill in the art and need not be configured as shown in the Figs. For example, a piano hinge distributed by Carroll Land Custom Furniture and Supply of Salisbury, N.C. may be used in accordance with one exemplary embodiment.

The hinge 52 may be attached proximate to the first end upper surface 48 and the intermediate upper surface 38 so as to allow the body-supporting member 34 in the first end 18 to pivot upwards with respect to the body-supporting member 34 in the body portion 12. FIGS. 2-4 show the body-supporting member 34 in the first end 18 adjusted upwards so as to better support the head of the user 36 during use of the creeper 10.

It should be understood that the present invention includes various modifications that can be made to the embodiments of the creeper 10 described herein as come within the scope of the appended claims and their equivalents.

What is claimed is:

1. A creeper, comprising:
a body portion having a longitudinal axis and a transverse axis perpendicular to said longitudinal axis;
an end portion that is adjustable with respect to said body portion;
a locking mechanism that engages both said body portion and said end portion, said locking mechanism configured for limiting the adjustability between said body portion and said end portion; and
an actuator configured to allow manual operation of said locking mechanism, said actuator having a first end connected to said locking mechanism, said actuator having a handle disposed opposite said first end and longitudinally disposed from said end portion.

2. The creeper as in claim 1, further comprising a plurality of casters attached to said body portion, and wherein at least two casters are located longitudinally between said end portion and said handle.

3. The creeper as in claim 1, wherein said body portion has a frame and a padded body-supporting member supported by said frame.

4. The creeper as in claim 1, wherein said handle is located away from a side of said body portion in the transverse direction.

5. The creeper as in claim 1, further comprising a hinge attached to both said body portion and said end portion.

6. The creeper as in claim 1, wherein said locking mechanism is configured for locking the position of said end portion with respect to said body portion.

7. The creeper as in claim 1, wherein said locking mechanism includes:
a first rod extending from said actuator generally in the transverse direction;
a second rod pivotally attached to said first rod and extending generally in the longitudinal direction; and
a third rod pivotally attached to said second rod and pivotally attached to said end portion.

8. The creeper as in claim 1, wherein said locking mechanism has an adjustment rack attached to said body portion that defines a plurality of adjustment locations that are configured to receive a first rod of said locking mechanism such that each adjustment location corresponds to a different adjustment position between said body portion and said end portion.

9. The creeper as in claim 1, wherein the heart of a user is located between said handle and said end portion in the longitudinal direction when a user lays on said body portion and rests his or her head on said end portion.

10. The creeper as in claim 1, wherein said end portion is adjustable so as to have an upper surface in substantially the same plane as an upper surface of said body portion, and wherein said handle is longitudinally disposed from said end portion a length at least as great or greater than the longitudinal length of said upper surface of said end portion when in substantially the same plane as said upper surface of said body portion.

11. A creeper, comprising:
a body portion having a longitudinal axis and a transverse axis perpendicular to said longitudinal axis, said body portion having an upper surface;
a plurality of casters attached to said body portion;
a hinge attached to said body portion;
an end portion attached to said hinge and adjustable with respect to said body portion, said end portion having an upper surface, wherein adjustment of said end portion includes changing the angular orientation of said upper surface of said end portion with respect to said upper surface of said body portion; and
a locking mechanism that engages both said body portion and said end portion, said locking mechanism configured for limiting the angular orientation of said upper surface of said end portion with respect to said upper surface of said body portion in at least one direction;
an actuator configured to allow manual operation of said locking mechanism, said actuator having a first end connected to said locking mechanism, and said actuator having a handle disposed opposite said first end and longitudinally disposed from said end portion and transversely disposed from said upper surface of said body portion.

12. The creeper as in claim 11, wherein said locking mechanism is configured for locking the angular orientation of said upper surface of said end portion with respect to said upper surface of said body portion.

13. The creeper as in claim 11, wherein at least two of said casters are located longitudinally between said end portion and said handle.

14. The creeper as in claim 11, wherein said locking mechanism has an adjustment rack attached to said body portion that defines a plurality of adjustment locations that are configured to receive a first rod of said locking mechanism such that each adjustment location corresponds to a different angular orientation between said upper surface of said body portion and said upper surface of said end portion.

15. The creeper as in claim 11, wherein said end portion is adjustable such that said upper surface of said end portion and said upper surface of said body portion are oriented to as to be substantially in the same plane.

16. The creeper as in claim 11, wherein said handle is longitudinally disposed from said hinge a length at least as great or greater than the longitudinal length of said end portion.

17. The creeper as in claim 11, wherein the heart of a user is located between said handle and said end portion in the longitudinal direction when a user lays on said upper surface of said body portion and rests his or her head on said upper surface of said end portion.

18. The creeper as in claim 11, wherein said handle is transversely disposed from the entire said body portion.

19. The creeper as in claim 11, wherein said locking mechanism includes:
a first rod extending from said handle generally in the transverse direction;
a second rod pivotally attached to said first rod and extending generally in the longitudinal direction; and
a third rod pivotally attached to said second rod and pivotally attached to said end portion.

20. A creeper, comprising:
a body portion having a longitudinal axis and a transverse axis perpendicular to said longitudinal axis, said body portion having an upper surface;
a plurality of casters attached to said body portion;
a hinge attached to said body portion and pivotable relative to said body portion;
an end portion attached to said hinge and adjustable with respect to said body portion, said end portion having an upper surface, wherein adjustment of said end portion includes changing the angular orientation of said upper surface of said end portion with respect to said upper surface of said body portion;
a locking mechanism that engages both said body portion and said end portion, said locking mechanism configured for locking the angular orientation of said upper surface of said end portion with respect to said upper surface of said body portion; and
an actuator configured to allow manual operation of said locking mechanism, said actuator having a first end connected to said locking mechanism, said actuator having a handle longitudinally disposed away from said end portion and transversely disposed from said upper surface of said body portion, wherein at least two casters are located longitudinally between said end portion and said handle.
